(19) United States
(12) Patent Application Publication
(10) Pub. No.: US 2017/0182602 A1
(43) Pub. Date: Jun. 29, 2017

(54) ALUMINUM ALLOY LAMINATE

(71) Applicant: Kabushiki Kaisha Kobe Seiko Sho (Kobe Steel, Ltd.), Kobe-shi (JP)

(72) Inventors: Katsushi MATSUMOTO, Hyogo (JP); Masao KINEFUCHI, Hygo (JP); Takahiro IZUMI, Tochigi (JP)

(73) Assignee: Kabushiki Kaisha Kobe Seiko Sho (Kobe Steel, Ltd.), Kobe-shi (JP)

(21) Appl. No.: 15/129,767

(22) PCT Filed: Mar. 25, 2015
(86) PCT No.: PCT/JP15/59228

§ 371 Date: Sep. 27, 2016

(30) Foreign Application Priority Data
Mar. 31, 2014 (JP) 2014-074200

(51) Int. Cl. B23K 35/28; C22C 21/00; B32B 15/20; C22F 1/04; B32B 15/01; B32B 15/04

(52) U.S. Cl. CPC B23K 35/286; B32B 15/016; B32B 15/043; B32B 15/20; C22F 1/04; C22C 21/00

(57) ABSTRACT

A laminated aluminum alloy sheet that includes a core material and a sacrificial material being clad on at least one side surface of the core material. The core material contains Mn: from 0.5 to 1.8 mass %, Si: from 0.4 to 1.5 mass % and Cu: from 0.05 to 1.2 mass %, and contains at least one member of Fe: 1.0 mass % or less and Ti: 0.3 mass % or less, with the remainder being Al and unavoidable impurities. The core material has a number density of dispersoids having a particle diameter of 0.01 to 0.5 um of from 20 to 80/um³.

### TECHNICAL FIELD

The present invention relates to a laminated aluminum alloy sheet used for a heat exchanger of an automobile, etc.

### BACKGROUND ART

In general, as a tube material used for a refrigerant passage of an automotive heat exchanger such as radiator, evaporator and condenser, various laminated aluminum alloy sheets (hereinafter, sometimes referred to as “laminated sheet”) obtained by cladding a brazing filler material and a sacrificial material on one surface or both surfaces of a core material are used.

The laminated sheet is suitably applied as a tube material of a heat exchanger and therefore, must have certain or higher levels of strength, corrosion resistance, erosion resistance, fatigue properties, etc., and a large number of techniques focusing on this point have been heretofore proposed.

For example, Patent Document 1 discloses a laminated sheet where in the core material, the number density of intermetallic compounds each having a predetermined size (from 0.02 to 0.2 μm) is limited to a range of 10 to 2,000/μm³. According to this technique, by limiting the number density of the intermetallic compound, the strength after brazing and the corrosion resistance of the laminated sheet can be enhanced.

Patent Document 2 discloses a laminated sheet where in the core material, the number of intermetallic compounds each having a predetermined size (from 0.01 to 0.1 μm) is limited to 5 or less in a 2 μm×2 μm visual field. According to this technique, by limiting the number of intermetallic compounds in a predetermined visual field, the erosion resistance can be enhanced without deteriorating the formability of the laminated sheet.

Patent Document 3 discloses a laminated sheet where in the core material, the average number density of precipitates in a range of 0.1 to 0.5 μm is specified to be 150/μm³ or less. According to this technique, by limiting the average number density of precipitates, the fatigue properties of the laminated sheet can be improved.

Patent Document 4 discloses a laminated sheet where in the core material, Cu is limited to a range of more than 0.5 mass % and 1.0 mass % or less and the grain size in the rolling direction is limited to a range of 150 to 200 μm. According to this technique, by controlling the Cu content and grain size of the core material, the fatigue properties of the laminated sheet can be enhanced.

### PRIOR ART LITERATURE

### Patent Document

Patent Document 1: JP-A-8-246117

Patent Document 2: JP-A-2002-126894

Patent Document 3: JP-A-2009-191293

Patent Document 4: JP-A-2003-82427

### SUMMARY OF THE INVENTION

### Problems that the Invention is to Solve

However, the recent trend toward weight reduction of a heat exchanger of an automobile, etc. leads to a demand for more thickness reduction (more than 0.2 mm at present→0.2 mm or less) of a tube material, and therefore decrease in the strength and erosion resistance resulting from the thickness reduction must be prevented. In other words, it is required to more enhance the strength and erosion resistance of the laminated sheet.

In addition, the pressure of a refrigerant used for a heat exchanger of an automobile, etc. is recently set to be higher than ever before, and further enhancement of fatigue properties (fatigue life) is also required so that the tube material of the heat exchanger can withstand such harsh use conditions.

As to the enhancement of fatigue properties, it is important to enhance the fatigue life including not only the fatigue life in an elastic region of the tube material of a heat exchanger (specifically, the fatigue life expressed under repeated stress in an elastic region) but also the fatigue life in a plastic region of the tube material (specifically, the fatigue life expressed under repeated stress in a plastic region) when the strain amount is further increased. However, there are many unclear points regarding the method and the like for enhancing the fatigue properties including the fatigue life in such a plastic region.

Although it is described in detail later by comparison with the present invention, the laminated sheets according to Patent Documents above are produced by a predetermined production process and therefore, are considered to be incapable of sufficiently exerting strength and erosion resistance at levels required for the laminated sheet of a future heat exchanger of an automobile, etc.

Furthermore, in the laminated sheets according to the Patent Documents above, the sheet thickness is often set to be thick (250 μm or more) and by the setting of such a degree of sheet thickness, the rigidity, etc. can be ensured to a certain extent. However, the trend toward thickness reduction and higher refrigerant pressure unavoidably entails a decrease in the rigidity, etc., naturally reducing the fatigue properties (fatigue life). Therefore, they are considered not to have fatigue properties at levels required for the laminated sheet of a future heat exchanger of an automobile, etc.

The present invention has been made in consideration of these points, and an object thereof is to provide a laminated aluminum alloy sheet excellent in the strength (strength after brazing), erosion resistance and fatigue properties.

### Means for Solving the Problems

The present inventors have found that the number density of dispersoids before heating corresponding to brazing greatly affects the average grain size, the average aspect ratio and the proportion of small-angle grain boundaries after heating corresponding to brazing and eventually governs the strength, erosion resistance and fatigue properties, and have created the present invention.

More specifically, the laminated aluminum alloy sheet according to the present invention for solving the problems above is a laminated aluminum alloy sheet including a core material and a sacrificial material being clad on at least one side surface of the core material, in which the core material contains Mn: from 0.5 to 1.8 mass %, Si: from 0.4 to 1.5 mass % and Cu: from 0.05 to 1.2 mass %, and contains at least one member of Fe: more than 0 mass % and 1.0 mass % or less and Ti: more than 0 mass % and 0.3 mass % or less, with the remainder being Al and unavoidable impurities, and the core material has a number density of dispersoids having a particle diameter of 0.01 to 0.5 μm of from 20 to 80/μm³.

In the laminated aluminum alloy sheet above, the number density of dispersoids is controlled to a predetermined range while controlling the amount of each element in the core material to a predetermined amount, whereby the strength (strength after brazing), the erosion resistance and the fatigue properties can be enhanced.

In the laminated aluminum alloy sheet according to the present invention, the core material preferably further contains at least one member of Cr: from 0.02 to 0.4 mass % and Zr: from 0.02 to 0.4 mass %.

In the laminated aluminum alloy sheet above, predetermined amounts of Cr and Zr are incorporated, whereby reduction in the formability can be prevented and the number density of dispersoids in the core material can be more reliably controlled to the predetermined range.

In the laminated aluminum alloy sheet according to the present invention, the core material preferably further contains Zn: more than 0 mass % and 1.0 mass % or less.

In the laminated aluminum ally sheet above, a predetermined amount of Zn is incorporated, whereby the strength of the core material can be further increased.

In the laminated aluminum alloy sheet according to the present invention, the core material preferably further contains Mg: more than 0 mass % and 1.0 mass % or less.

In the laminated aluminum ally sheet above, a predetermined amount of Mg is incorporated, whereby the strength of the core material can be further increased.

The laminated aluminum alloy sheet according to the present invention preferably has a sheet thickness of 0.2 mm or less.

In the laminated aluminum ally sheet above, the sheet thickness is 0.2 mm or less, whereby the requirement for weight reduction of a heat exchanger of an automobile, etc. can be satisfied.

It is preferable that in the laminated aluminum alloy sheet according to the present invention, the core material has, as a microstructure after a heating corresponding to a brazing of the laminated aluminum alloy sheet, an average grain size in a rolling direction, in a longitudinal cross-section along the rolling direction, of 50 μm or more, the core material has, as the microstructure, an average aspect ratio (average grain size in rolling direction/average grain size in sheet thickness direction) of grains of 3.0 or more, and the core material has, as the microstructure, a proportion of a small-angle grain boundary having a tilt angle of 5 to 15° of 10.0% or less.

In the laminated aluminum alloy sheet above, with respect to the microstructure of the core material after heating corresponding to brazing, the average grain size, the average aspect ratio and the small-angle grain boundary are further controlled, whereby the strength (strength after brazing), the erosion resistance and the fatigue properties can be more reliably enhanced.

### Advantage of the Invention

In the laminated aluminum alloy sheet according to the present invention, the amount of each element in the core material is controlled to a predetermined amount and at the same time, with respect to the microstructure of the core material, the number density of dispersoids is controlled to a predetermined range, whereby the strength (strength after brazing), the erosion resistance and the fatigue properties can be enhanced.

### MODE FOR CARRYING OUT THE INVENTION

The laminated aluminum alloy sheet according to the embodiment is described in detail below.

### <<Laminated Aluminum Alloy Sheet>>

The laminated aluminum alloy sheet (brazing sheet) is a sheet material used for, e.g., a member of a heat exchanger of an automobile, etc. and is a sheet material where a sacrificial material is clad on at least one side surface of a core material. It generally has a three-layer structure consisting of a core material, a sacrificial material clad on one side surface of the core material and a blazing filler material clad on another side surface of the core material, but may have a four-layer structure where one more layer of an aluminum alloy material is clad between the core material and the brazing filler material.

The laminated aluminum alloy sheet preferably has a sheet thickness of 0.2 mm or less.

Many of conventional laminated aluminum alloy sheets are set to have a sheet thickness of more than 0.2 mm, and the performances such as strength are secured by setting the sheet thickness to be thick, but the trend toward thickness reduction makes it difficult to ensure these performances, i.e., setting of the sheet thickness to 0.2 mm or less expressly presents a problem of reduction in these performances.

In other words, the laminated aluminum alloy sheet according to the present invention can exert, when the sheet thickness is 0.2 mm or less, a remarkable effect (improvement of strength, erosion resistance and fatigue properties) that cannot be exerted by conventional laminated aluminum alloy sheets.

### <Core Material>

The core material contains Mn: from 0.5 to 1.8 mass %, Si: from 0.4 to 1.5 mass %, Cu: from 0.05 to 1.2 mass %, and contains at least one member of Fe: more than 0 mass % and 1.0 mass % or less and Ti: more than 0 mass % and 0.3 mass % or less, with the remainder being Al and unavoidable impurities. In the core material, the number density of dispersoids having a predetermined particle diameter is from 20 to 80/μm³.

The core material preferably further contains at least one member of Cr: from 0.02 to 0.40 mass % and Zr: from 0.02 to 0.40 mass % and further contains Zn: 1.0 mass % or less and Mg: 1.0 mass % or less.

The reasons for limiting numerical values regarding each composition and the number density of dispersoids of the core material in the laminated aluminum alloy sheet according to the present invention are described below.

### (Mn: From 0.5 to 1.8 Mass %)

Mn is an element for allowing dispersoids of the predetermined size specified by the present invention to be distributed in an aluminum alloy sheet and enhancing the strength by dispersion hardening without deteriorating the corrosion resistance of the core material. Accordingly, in order to ensure the strength required for a laminated sheet before and after heating corresponding to brazing, Mn is incorporated in an amount of 0.5 mass % or more.

On the other hand, if the Mn content is too large, this element may work out to a starting point of crack initiation in plastic deformation, or the number density of coarse Al—Fe—Mn—Si dispersoids may be increased to deteriorate the formability of the laminated sheet and to cause breakage of the laminated sheet during processing such as assembly into a component shape. Therefore, the Mn content is set to 1.8 mass % or less.

The Mn content range is therefore set to be a range of from 0.5 to 1.8 mass %.

### (Si: From 0.4 to 1.5 Mass %)

Si forms a solid solution in the matrix to provide the strength necessary for the core material (a member for a heat exchanger).

However, since Si is also consumed by an Al—Mn—Si dispersoid, Si is incorporated in an amount of 0.4 mass % or more also for ensuring the solute Si amount. In addition, Si also has an effect of increasing the strength of the core material particularly by forming the Al—Mn—Si dispersoid above. If the Si content is less than 0.4 mass %, the above-described effect cannot be sufficiently obtained. On the other hand, if the Si content is too large, the melting point of the core material is lowered, and due to an increase in a low-melting-point phase, melting of the core material occurs in brazing. Therefore, the Si content is set to 1.5 mass % or less.

The Si content range is therefore set to be a range of from 0.4 to 1.5 mass %.

### (Cu: From 0.05 to 1.2 Mass %)

Cu is an element for increasing the strength of the core material by existing in a solid-solution state in the aluminum alloy sheet and also enhances the corrosion resistance on the brazing filler material side.

However, if the Cu content is too large, a coarse Cu compound precipitates in the grain boundary during cooling after heating corresponding to brazing, making it likely for grain boundary corrosion to occur, and the corrosion resistance as a laminated sheet after heating corresponding to brazing is reduced. In addition, since the melting point of the core material lowers, melting of the core material is caused during brazing. Accordingly, the Cu content is set to 1.2 mass % or less. In addition, for ensuring the strength required for a laminated sheet before and after heating corresponding to brazing, Cu must be incorporated in an amount of 0.05 mass % or more.

The Cu content range is therefore set to be a range of from 0.05 to 1.2 mass %.

(Fe: More than 0 Mass % and 1.0 Mass % or Less)

Fe is inevitably contained as an impurity in the core material as long as scraps are used as the aluminum alloy melting raw material. Fe forms an intermetallic compound with Si to increase the strength of the core material and also has an effect of enhancing the brazing property of the core material. However, if the content thereof is too large, the self-corrosion resistance of the core material is significantly reduced. In addition, a coarse compound may be formed to deteriorate the formability of the laminated sheet and to cause breakage of the laminated sheet during processing such as assembly into a component shape.

Therefore, the Fe content range is set to be more than 0 mass % and 1.0 mass % or less.

The lower limit value of the Fe content is preferably 0.01 mass % and more preferably 0.05 mass %, and the upper limit is preferably 0.8 mass % and more preferably 0.5 mass %.

(Ti: More than 0 Mass % and 0.3 Mass % or Less)

Ti has a function of forming a fine intermetallic compound in the aluminum alloy sheet and enhancing the corrosion resistance of the core material. However, if the Ti content is too large, a coarse compound may be formed to deteriorate the formability of the laminated sheet and to cause breakage of the laminated sheet during processing such as assembly into a component shape.

Therefore, the Ti content range is set to be more than 0 mass % and 0.3 mass % or less.

When Ti is added, it precipitates in layer form in the core material to suppress the progress of pitting corrosion in the depth direction and at the same time, the addition of Ti can shift the electric potential of the core material to a noble side. Furthermore, Ti exhibits a small diffusion rate in the aluminum alloy and moves little during brazing, and the addition of Ti thus provides an effect of maintaining a potential difference between the core material and the brazing filler material or between the core material and the sacrificial material and thereby electrochemically preventing corrosion of the core material. In addition, since Ti precipitates in layer form in the core material, a pinning effect is exerted on the grain boundary movement to suppress the growth of a grain in the sheet thickness direction and promote the growth thereof in the rolling plane, and grains thereby form a layered configuration, which effectively acts on the enhancement of fatigue properties and erosion resistance. In order to ensure the corrosion resistance, fatigue properties and erosion resistance required for a laminated sheet before and after heating corresponding to brazing, this element is preferably incorporated in an amount of 0.03% or more. The upper limit value of the Ti content is preferably 0.2 mass % and more preferably 0.1 mass %.

The brazing property, corrosion resistance, fatigue properties, and erosion resistance of the laminated sheet can be enhanced by incorporating at least one member of Fe and Ti in the content range above.

### (Cr: From 0.02 to 0.4 Mass %, Zr: From 0.02 to 0.4 Mass %)

Cr and Zr are elements for distributing precipitates (intermetallic compounds) in a submicron-level size of 100 nm or less in terms of the equivalent-circle diameter in the aluminum alloy sheet, and at least one of these is incorporated. Among these, Zr is particularly most effective for distributing fine dispersoids in the aluminum alloy sheet. If each of Cr and Zr is less than the specified lower limit amount, fine dispersoids cannot be sufficiently distributed, failing in obtaining the effect of enhancing the strength by dispersion hardening. Precipitates by these additive elements precipitate during soaking and hot rolling to be a form of being distributed in layer form in the rolling direction. Accordingly, similarly to Ti, they have an effect of pinning the grain boundary to suppress the growth of a grain in the sheet thickness direction and promote the growth thereof in the rolling plane and thereby forming a layered configuration of grains and thus effectively act on the enhancement of fatigue properties and erosion resistance. In order to obtain this effect, each element needs to be added in an amount of not less than the specified lower limit.

On the other hand, if each of Cr and Zr is in a too large amount exceeding the specified upper limit, a coarse compound may be formed to deteriorate the formability of the laminated sheet and to cause breakage of the laminated sheet during processing such as assembly into a component shape.

Therefore, in the case of incorporating Cr and Zr, Cr is preferably in a range of from 0.02 to 0.4 mass % and Zr is preferably in a range of from 0.02 to 0.4 mass %.

(Zn: More than 0 Mass % and 1.0 Mass % or Less)

Zn has an effect of increasing the strength of the core material by precipitation hardening. However, Zn has an action of causing the matrix to have a less noble electric potential and be preferentially corroded and therefore, if the content of Zn in the core material is large, the difference in electric potential between the sacrificial material provided as a preferential corrosion layer and the core material becomes small, leading to deterioration of the corrosion resistance.

Therefore, in the case of incorporating Zn, the Zn content range is preferably more than 0 mass % and 1.0 mass % or less.

The lower limit value of the Zn content is preferably 0.01 mass % and more preferably 0.05 mass %. The upper limit value is preferably 0.8 mass % and more preferably 0.5 mass %.

(Mg: More than 0 Mass % and 1.0 Mass % or Less)

Mg has an effect of increasing the strength of the core material, but if its content is large, diffusion of Mg greatly affects the brazing filler material and, for example, in a Nocolok brazing method using a fluoride-based flux, the Mg reacts with a fluoride-based flux applied onto the brazing filler material surface in brazing, as a result, the brazing property is significantly reduced.

Therefore, in the case of incorporating Mg, the Mg content range is preferably more than 0 mass % and 1.0 mass % or less.

In the case of a laminated sheet for a heat exchanger, where the brazing property is deteriorated by Mg, the Mg content is preferably restricted to 0.8 mass % or less.

The lower limit value of the Mg content is preferably 0.05 mass % and more preferably 0.1 mass %.

(Remainder being Al and Unavoidable Impurities)

Other than the above, the components of the core material contains the remainder being Al and unavoidable impurities. Unavoidable impurities include, for example, V and B, in addition to the above-described Cr, Zr, Zn, and Mg which are selectively added.

### (Number Density of Dispersoids)

In the core material of the laminated sheet before heating corresponding to brazing, the number density of dispersoids having a particle diameter of 0.01 to 0.5 μm is from 20 to 80/μm³.

In order to configure the microstructure specified regarding the core material of the laminated sheet after heating corresponding to brazing (at the stage of a member for a heat exchanger), the core material of the laminated sheet before heating corresponding to brazing (at the stage of a material) must satisfy the above-described condition on the number density of dispersoids.

In heating corresponding to brazing, the distortion accumulated disappears in the course of raising the temperature and in that process, discontinuous recrystallization or continuous recrystallization is generated to form a new grain microstructure. Here, fine dispersoids formed from the originally added Mn element or a transition element added additionally are formed in layer form in the rolling direction, as a result, the growth of a grain in the sheet thickness direction is suppressed, and the growth of a recrystallized grain in the rolling direction or the width direction is promoted. Dispersoids in the above-mentioned size range provide a strong grain boundary pinning effect and as the number density thereof is larger, the tendency of distribution in layer form in the rolling direction is stronger. As a result, the effect of suppressing the growth of a grain in the sheet thickness direction becomes prominent. In turn, the growth of a recrystallized grain in the rolling direction or the rolling width direction is promoted to bring about growth of a grain in the rolling plane and an increase in the aspect ratio, contributing to an increased fatigue life. If the number density of dispersoids in the above-mentioned size range is less than the lower limit, the effect of suppressing the growth of a grain in the sheet thickness direction cannot be obtained, allowing a grain to readily grow also in the sheet thickness direction, and the desired aspect ratio cannot be obtained, as a result, the fatigue life is reduced. If the number density of dispersoids in the above-mentioned size range exceeds the upper limit, these dispersoids remain, even after heating corresponding to brazing, in a state close to the state before heating corresponding to brazing, and since the average number density of dispersoids assuming crack propagation in fatigue fracture is increased to encourage this behavior, the fatigue life in the case of fatigue fracture propagation being predominant is reduced.

In order to ensure the effect above, the number density of dispersoids having a particle diameter of 0.01 to 0.5 μm is preferably from 30 to 70/μm³.

The dispersoid as used in the present invention is a generic term of intermetallic compounds, which can be distinguished by the above-described size through microstructure observation irrespective of forming elements (composition), and which are an intermetallic compound of alloy elements, such as Si, Cu, Mn, and Ti, and/or elements contained, such as Fe and Mg, or an intermetallic compound of such an element and Al.

### <Sacrificial Material and Brazing Filler Material>

The sacrificial material (sacrificial anti-corrosive material, sacrificed material, lining material, skin material) and the brazing filler material (brazing material) are not particularly limited.

As to the sacrificial material, for example, a known sacrificial material aluminum alloy containing Zn, such as 7000-series aluminum alloy, e.g., JIS7072, having an Al—Zn composition that has been conventionally used for general purposes, can be used.

As to the brazing filler material, for example, a known brazing filler material aluminum alloy, such as 4000-series Al—Si alloy brazing filler material, e.g., JIS4043, 4045 or 4047, having an Al—Si composition that has been conventionally used for general purposes, can be used.

The laminated aluminum alloy sheet after heating corresponding to brazing according to the embodiment is described below.

The heating corresponding to brazing as used in the present invention indicates heating simulating brazing usually performed when processing a laminated sheet into a member (tube material) for a heat exchanger and is more specifically a heat treatment where after applying a pre-strain of 10%, heating at a temperature of 600° C. for 3 minutes and holding are performed and then cooling at an average cooling rate of 100° C./min is performed.

<Core Material after Heating Corresponding to Brazing>

In the case of subjecting the laminated sheet to heating corresponding to brazing, the composition of chemical components of the core material does not change.

However, during heating corresponding to brazing, the distortion accumulated disappears in the course of raising the temperature, and in this process, discontinuous recrystallization or continuous recrystallization is generated to form a new grain microstructure. Here, dispersoids formed from the originally added Mn element or a transition element added additionally affect the average grain size, the average aspect ratio and the proportion of small-angle grain boundaries during recrystallization. The average grain size, the average aspect ratio and the proportion of small-angle grain boundaries of the core material are controlled to the following desired ranges by controlling the number density of dispersoids having a particle diameter of 0.01 to 0.5 μm to a range of 20 to 80/μm³.

### (Average Grain Size)

With respect to the core material of the laminated sheet after heating corresponding to brazing, the average grain size in the rolling direction, in a longitudinal cross-section along the rolling direction (a cross-section of the sheet cut along the rolling direction) is 50 μm or more.

When the average grain size in the rolling direction is 50 μm or more at the stage after heating corresponding to brazing (at the stage of a member for a heat exchanger), the effect of enhancing the erosion resistance can be ensured. On the other hand, if the average grain size in the rolling direction is less than 50 μm, the erosion resistance is reduced. The average grain size in the rolling direction is preferably 80 μm or more and more preferably 150 μm or more.

### (Average Aspect Ratio)

With respect to the core material of the laminated sheet after heating corresponding to brazing, the average aspect ratio (average grain size in rolling direction/average grain size in sheet thickness direction) of a grain is 3.0 or more.

When the average aspect ratio is 3.0 or more, the grain size in the sheet thickness direction relative to the grain size in the rolling direction becomes small (the number of grains in the sheet thickness direction is increased), providing resistance to crack development in fatigue failure, and the fatigue life (fatigue properties) is enhanced. On the other hand, if the average aspect ratio is less than 3.0, the resistance to crack development in fatigue fracture cannot be sufficiently obtained, and the fatigue life is reduced. The average aspect ratio is preferably 4.0 or more.

### (Proportion of Small-Angle Grain Boundaries)

With respect to the core material of the laminated sheet after heating corresponding to brazing, the proportion of small-angle grain boundaries having a tilt angle of 5 to 15° is 10.0% or less.

When the proportion of small-angle grain boundaries in grain boundaries is 10.0% or less, the effect of the grain boundary providing resistance to crack development in fatigue fracture is sufficiently exerted, and the fatigue life is enhanced. On the other hand, if the proportion of small-angle grain boundaries exceeds 10.0%, the resistance to crack development in fatigue facture cannot be sufficiently obtained, and the fatigue life is reduced. The proportion of small-angle grain boundaries is preferably 8.0% or less.

The method for manufacturing the laminated aluminum alloy sheet according to the embodiment is described below.

### <<Manufacturing Method of Laminated Aluminum Alloy Sheet>>

First, a core material, a sacrificial material and a brazing filler material, which are materials of the laminated aluminum alloy sheet, are manufactured.

The methods for manufacturing a core material, a sacrificial material and a brazing filler material are not particularly limited. For example, an aluminum alloy for a core material having the above-described composition is cast at a predetermined casting temperature, and the obtained slab is then scalped to a desired thickness and subjected to a homogenization heat treatment, whereby the core material can be manufactured. In addition, each of an aluminum alloy for a sacrificial material and an aluminum alloy for a brazing filler material having a predetermined composition is cast at a predetermined casting temperature, and the obtained slab is scalped to a desired thickness and subjected to a homogenization heat treatment.

Thereafter, the sacrificial material is stacked on one side surface of the core material and the brazing filler material is stacked on another side surface thereof, followed by cladding, to forma sheet material. This sheet material is subjected to hot rolling and to cold rolling while applying intermediate annealing so as to manufacture a laminated sheet.

### <About Manufacturing Conditions>

In order to appropriately control the dispersoid configuration of the core material before heating corresponding to brazing and the grain configuration after heating corresponding to brazing, the soaking step needs to be elaborately controlled.

Specifically, the average temperature rise rate in a high-temperature region during temperature rise is controlled to a predetermined range so as to control the increase of the solid solution amount in a high-temperature region during soaking and the number density of fine precipitates, and to suppress the formation of a coarse precipitate. In detail, the temperature is raised at an average temperature rise rate of 20° C./hr of more and 200° C./hr or less in a temperature region of 400° C. or more. Fine precipitates produced in a temperature region of less than 400° C. in the temperature rising process are encouraged to form a solid solution in the subsequent temperature rising process, and when the temperature is raised in the temperature rise rate range above in a temperature region of 400° C. or more where the diffusion rate of atoms is also high and the precipitate is consequently liable to grow, not only solid-solution formation is accelerated to increase the solid solution amount while suppressing growth/remaining of fine precipitates but also the number density of precipitates in a desired size range falls in the target range at the stage of a laminated sheet before brazing.

An average temperature rise rate exceeding 200° C./hr in a temperature region of 400° C. or more leads to enormous power consumption and is not practical in industry. If the average temperature rise rate is less than 20° C./hr, a large number of fine precipitates formed at less than 400° C. readily grows due to a decrease in the temperature rise rate, and coarse precipitates are likely to remain during solid solution formation in a high temperature region of 400° C. or more, as a result, the number density of precipitates in a desired size range falls below the target range. More preferably, in the temperature region of 400° C. or more, the temperature is preferably raised at an average temperature rise rate of 30° C./hr or more and 200° C./hr or less.

The achieving temperature of soaking is set to 450° C. or more, whereby a coarse Mg₂Si, Al—Mg—Cu—Si compound, etc. are dissolved in solid and the solid solution amount in the matrix is increased. Usually, as the solid solution amount in the matrix is larger, in recrystallization occurring in the later hot rolling step, it is directed to prevent development of a specific recrystallization orientation (for example, Cube orientation that outstandingly develops in pure aluminum, etc.) and provide a relatively random crystal orientation distribution. Consequently, development of a specific texture in the core material at the stage of a laminated sheet after cold rolling step but before heating corresponding to brazing is suppressed, and a specific crystal orientation is thereby prevented from developing in the later step of heating corresponding to brazing. As a result, the proportion of small-angle grain boundaries in the core material (sampled specimen) after heating corresponding to brazing is reduced to the target range.

If the achieving temperature of the soaking temperature is less than 450° C., the solid solution amount in the matrix is decreased, reducing the orientation randomizing effect in the hot rolling step, and the proportion of small-angle grain boundaries in the core material (sampled specimen) after heating corresponding to brazing eventually exceeds the target range.

The achieving temperature of soaking is more preferably 480° C. or more.

In view of the aspect ratio of a grain after heating corresponding to brazing, when the achieving temperature of the soaking temperature is 450° C. or more, fine dispersoids formed from the originally added Mn element or a transition element added additionally are formed in layer form in the rolling direction and since the growth of a grain in the sheet thickness is suppressed, when the soaking temperature is in the predetermined range, a grain having a predetermined aspect ratio is formed after the step of heating corresponding to brazing. However, if the achieving temperature of soaking is 550° C. or more, growth of a precipitate occurs, reducing the number density of precipitates, and although the above-mentioned aspect ratio may fall in the predetermined range, the aspect ratio becomes small. Thus, in view of the aspect ratio of a grain after heating corresponding to brazing, the temperature is preferably less than 550° C.

Cold rolling, annealing, etc. are applied after hot rolling, and the temper thereof may be either an H1n process (intermediate annealing is carried out during cold rolling and the finish is cold rolling) or an H2n process (without applying intermediate annealing during cold rolling, final annealing is carried out after cold rolling).

In the production process of the laminated sheet before heating corresponding to brazing, particularly after hot rolling, a plurality of annealing steps, such as rough annealing after hot rolling, intermediate annealing during cold rolling and finish annealing after cold rolling, are provided, but as the number of annealing treatments is larger, the solid solution amount in the core material matrix decreases. However, intermediate annealing and finish annealing are necessary for controlling the grain size configuration after heating corresponding to brazing and hardly be omitted in the case of performing the temper by an H1n or H2n process. Consequently, rough annealing is preferably omitted so as to decrease the number of annealing steps as much as possible.

### <<Member for Heat Exchanger>>

For processing the laminated aluminum alloy sheet according to the embodiment into a member for a heat exchanger, the laminated sheet is bent in the width direction by a forming roll, etc., formed in a flat tube shape so that the skin material is provided on the tube inner surface side, and then formed in a flat tube shape by electric sewing welding, etc., whereby a tube material can be manufactured.

The flat tube-shaped tube material (laminated member) is produced (assembled) as a heat exchanger, such as radiator, integrally with other members, such as corrugated radiating fin and header, by brazing. The portion where the tube material (laminated member) and the radiating fin are integrated is sometimes referred to as a core of the heat exchanger. Here, brazing treatment is carried out by heating at a high temperature of 585 to 620° C., preferably from 590 to 600° C., which is not less than the solidus temperature of the brazing filler material. As for the brazing technique, a flux brazing method, a Nocolok brazing method using a non-corrosive flux, etc. are used for general purposes.

The conditions in each of measurements of the number density of dispersoids, the average grain size, the average aspect ratio and the proportion of small-angle grain boundaries are described below.

### <<Conditions in Each Measurement>>

### <Conditions in Measurement of Number Density of Dispersoids>

A specimen is sampled from the sheet-thickness center of the core material and after mechanically polishing the specimen surface by 0.05 to 0.1 mm, followed by electrolytically etching to finish as a specimen for TEM observation. By observing dispersoids with FE-TEM (transmission electron microscope) at 50,000 power, the particle diameter and number density of dispersoids are measured.

The number density per unit volume of dispersoids is obtained by converting the number density of dispersoids relative to the area of visual fields in TEM observation to a number density per unit volume, by measuring and calculating the thickness t of the specimen for TEM observation according to a known contamination spot method.

The microstructure observation by FE-TEM at the sheet-thickness center of the core material is performed such that the total area of observation visual fields becomes 4 μm² or more per one place of sheet-thickness center, and observations are carried out at ten places spaced by an appropriate distance in the width direction (a direction perpendicular to rolling) of the sheet. The number density per unit volume of precipitates having a particle diameter in a range of 0.01 to 0.5 μm is determined for each place by analyzing respective images, and they are averaged to calculate the number density (average number density) per unit volume.

The particle diameter of a dispersoid as used in the present invention is a diameter by gravitational center and is a size when converted to an equivalent-circle diameter of dispersoid per one dispersoid (circle diameter: a diameter of an equivalent circle).

### <Conditions in Measurement of Average Grain Size>

The grain size after heating corresponding to brazing is a grain size in the rolling direction, in a longitudinal cross-section along the rolling direction (a cross-section of the sheet cut along the rolling direction), of the core material.

The aspect ratio of the grain size of the core material after heating corresponding to brazing is calculated as a ratio between a grain size in the rolling direction on the rolling plane at the sheet-thickness center of the core material and a grain size in the sheet-thickness direction in a longitudinal cross-section along the rolling direction of the core material.

In detail, the grain size in the rolling direction on the rolling plane at the center in the sheet thickness direction of the core material is measured by an intercept method (line intercept method) where the rolling plane at the center in the sheet thickness direction of the core material (sampled specimen) after heating corresponding to brazing is regulated by mechanical polishing and electropolishing and the length of an intercept is then measured as an individual grain size by using a 50-power optical microscope. This is measured at arbitrary ten places, and the average grain size is calculated. Here, on the conditions that the length of one measurement line is 0.5 mm or more and the number of measurement lines per visual field is 3, five visual fields are observed per measurement place. The average grain sizes sequentially measured for every measurement line are averaged in sequence for every one visual field (three measurement lines), for every five visual fields in one measurement place, and for every ten measurement places to determine the average grain size as used in the present invention.

As for the grain size in the sheet thickness direction in a longitudinal cross-section along the rolling direction of the core material, a longitudinal cross-section along the rolling direction of the core material (sampled specimen) of the laminated sheet after heating corresponding to brazing is regulated by mechanical polishing and electropolishing and then observed by using a 50-power optical microscope. Here, measurement by an intercept method (line intercept method) is performed where a straight line in the sheet thickness direction is drawn and the length of an intercept of individual grains located on the straight line is measured as an individual grain size. This is measured at arbitrary ten places, and the average grain size is calculated. Here, on the conditions that the length of one measurement line is 0.1 mm or more and the number of measurement lines per visual field is 5, five visual fields are observed per measurement place. The average grain sizes sequentially measured for every measurement line are averaged in sequence for every one visual field (five measurement lines), for every five visual fields in one measurement place, and for every ten measurement places to determine the average grain size in the sheet thickness direction.

The average aspect ratio as used in the present invention is calculated by taking the ratio of the average grain size in the rolling direction to the average grain size in the sheet thickness direction described above.

### <Conditions in Measurement of Small-Angle Grain Boundary>

The proportion of small-angle grain boundaries in the present invention is measured by a crystal orientation analysis method using an electron backscatter diffraction pattern EBSD (Electron BackScatter Diffraction pattern) through a scanning electron microscope SEM (Scanning Electron Microscope) or a field-emission scanning electron microscope FE-SEM (Field Emission Scanning Electron Microscope).

Specifically, the rolling plane at the center in the sheet thickness direction of the core material (sampled specimen) in the laminated sheet after heating corresponding to brazing is subjected to mechanical polishing and buff polishing and then electropolished to regulate the surface.

SEM and FE-SEM used for the measurement may be any device manufactured, for example, by JEOL Ltd., SII NanoTechnology Inc., Hitachi High-Technologies Corporation, or other manufacturers, and EBSD and the analysis software therefor may be “OIM Analysis” produced by TSL, “Channel 5” produced by HKL, or any device and analysis software produced by other manufacturers.

As for the EBSD measurement conditions, EBSD measurement is performed in measurement steps of 4 μm in a measurement visual field of 1,000 μm×1,000 μm by setting the magnification of SEM or FESEM to 25 times. In the EBSD map obtained by the measurement, a grain boundary must be first determined. The crystal orientation at each measurement point is analyzed in the data of two-dimensionally measured crystal microstructure, and the boundary between measurement points when the orientation difference between adjoining measurement points becomes 50 or more is defined as the grain boundary. That is, particles with an orientation difference of less than 5° are regarded as substantially one particle, and in this measurement, one grain means a microstructure surrounded by a grain boundary having an orientation difference of 5° or more. In the microstructure measured two-dimensionally and analyzed, a boundary line (grain boundary) connecting three gravitational centers of the grain boundary is regarded as a grain boundary having one specific orientation difference. As to the grain boundary defined above, the proportion of grain boundaries having an orientation difference of 5° or more and 15° or less (small-angle grain boundaries) in all grain boundaries is determined. In the rolling plane at the sheet-thickness center of the core material, where the measurement and analysis above are performed, the proportion of small-angle grain boundaries is measured at arbitrary ten places, and the average value of the proportions determined at respective places is obtained.

### Examples

The present invention is described more specifically below by referring to Examples, but the present invention is not limited to these Examples and can be implemented by appropriately adding changes as long as the gist described above and below is observed, and these all are included in the technical scope of the present invention.

### <Manufacture of Laminated Sheet>

The laminated sheet was manufactured as follows.

A 3000-series aluminum alloy composition having the composition of A to V shown in Table 1 was melted and cast to manufacture an aluminum alloy core material slab. As for only this core material slab, the solid solution amount of an alloy element was controlled by variously changing the soaking temperature as shown in Table 2.

Thereafter, on one surface of the core material slab, a JIS7072 aluminum alloy sheet composed of an Al-1 wt % Zn composition was clad as a sacrificial anti-corrosive material, and on another surface thereof, a JIS4045 aluminum alloy sheet composed of an Al-10 wt % Si composition was clad as a brazing material.

The clad sheet above was hot-rolled and to cold-rolled while applying intermediate annealing to obtain a laminated sheet as an H14 temper material or an H24 temper material. In applying each treatment, in each Example, the soaking temperature was variously changed together with the average temperature rise rate during soaking as shown in Table 2 so as to control the solid solution amount of an alloy element, whereby a laminated sheet before brazing was produced. In addition, holding during soaking was performed for 6 hr in either case, and holding during reheating was performed for 2 hr. Except for certain Example (Comparative Example No. 31), rough annealing after hot rolling was omitted. In the H14 temper process, as the intermediate annealing conditions, annealing of 400° C.×4 hr was applied in a batch furnace. The temperature rise/drop rate in the case was 40° C./hr.

In Table 2, the temper process of Example Nos. 1 to 13 and Comparative Example Nos. 19 to 28, 30 and 32 is an H14 temper process, and the temper process of Example Nos. 14 to 18 and Comparative Example Nos. 29 and 31 is an H24 temper process.

Commonly in each Example, the sheet thickness of the core material was 0.14 mm, and both the brazing filler material and the sacrificial material stacked respectively on one surface and another surface of the core material had a thickness in the range of 20 to 30 μm.

Comparative Example No. 30 is a laminated sheet manufactured by the method described in Patent Document 1, Comparative Example No. 31 is a laminated sheet manufactured by the method described in Patent Document 2, and Comparative Example No. 32 is a laminated sheet manufactured by the method described in Patent Document 3. With respect to Comparative Example No. 31, the time after the completion of reheating until starting hot rolling was set to 30 minutes and, as rough annealing conditions, a heat treatment of 450° C.×3 hr and a heat treatment of 350° C.×10 hr were further applied. Furthermore, the final annealing after cold rolling was performed at a temperature rise rate of 20° C./hr.

TABLE 1

| | | Component Composition of Core Material Al Alloy Sheet | | | | | | | | |
|---|---|---|---|---|---|---|---|---|---|---|
| Divi- | | (mass %, remainder: Al) | | | | | | | | |
| sion | Code | Mn | Si | Cu | Mg | Fe | Ti | Cr | Zr | Zn |
| Ex. | A | 1.1 | 0.7 | 0.8 | — | 0.1 | — | — | — | — |
| | B | 1.0 | 0.6 | 0.8 | — | 0.1 | 0.1 | — | — | — |
| | C | 1.0 | 0.9 | 0.8 | — | 0.1 | 0.1 | — | — | — |
| | D | 1.0 | 0.8 | 0.7 | 0.2 | 0.1 | 0.1 | — | 0.02 | — |
| | E | 1.0 | 0.9 | 0.6 | 0.3 | 0.1 | 0.1 | — | 0.1 | — |
| | F | 0.8 | 1.2 | 0.7 | — | 0.1 | 0.1 | — | 0.3 | — |
| | G | 1.0 | 1.5 | 0.05 | 0.35 | 0.3 | 0.1 | 0.03 | 0.4 | — |
| | H | 1.0 | 0.7 | 0.5 | 0.1 | 0.1 | 0.1 | 0.1 | 0.15 | — |
| | I | 1.2 | 0.8 | 1.1 | — | 0.1 | 0.1 | 0.15 | — | — |
| | J | 0.5 | 1.0 | 1.2 | 0.25 | 1.0 | 0.1 | 0.4 | 0.1 | 0.2 |
| | K | 1.7 | 0.5 | 0.3 | 0.8 | 0.5 | 0.1 | — | — | — |
| | L | 1.4 | 0.5 | 0.4 | 0.4 | 0.1 | 0.03 | — | 0.1 | — |
| | M | 1.0 | 0.8 | 0.7 | — | 0.1 | 0.3 | 0.1 | — | 0.8 |
| | N | 1.4 | 0.8 | 0.5 | — | 0.1 | 0.1 | — | — | — |
| Com. | O | 1.0 | 0.25 | 0.7 | — | 0.1 | 0.1 | — | 0.15 | — |
| Ex. | P | 1.0 | 0.8 | — | — | 0.1 | 0.1 | — | 0.15 | — |
| | Q | 0.4 | 0.7 | 0.7 | — | 0.1 | 0.1 | — | 0.15 | — |
| | R | 1.0 | 0.8 | 0.8 | — | 1.2 | 0.1 | — | 0.1 | — |
| | S | 2.0 | 0.9 | 0.7 | — | 0.1 | — | — | 0.6 | — |
| | T | 0.8 | 0.8 | 1.4 | — | 0.1 | 0.1 | 0.6 | — | — |
| | U | 1.0 | 1.2 | 0.6 | 0.2 | 0.1 | 0.5 | — | — | — |
| | V | 1.0 | 1.8 | 0.7 | — | 0.1 | 0.1 | 0.1 | 0.15 | 1.2 |

### <Composition of Core Material>

After the production of the laminated material, the microstructure of the core material portion at the stage of a material (before being assembled to form a heat exchanger) was measured. Furthermore, brazing in processing of the laminated sheet into a member (tube material) for a heat exchanger was simulated by applying a pre-strain of 10% and thereafter, performing a heat treatment including heating at a temperature of 600° C. for 3 minutes, holding and then cooling at an average cooling rate of 100° C./min, and the microstructure of the core material portion of the laminated sheet after this heat treatment was measured.

### <Other Measured Values of Core Material>

As for the number density of dispersoid, the average grain size, the average aspect ratio and the proportion of small-angle grain boundaries, of the core material was measured based on the measurement conditions described above.

### <Mechanical Properties>

With respect to each Example after the heat treatment simulating brazing, the tensile strength (MPa) was measured by performing a tensile test. As for the test conditions, the tensile test was performed by sampling a JIS Z2201 No. 5 test piece (25 mm×50 mmGL×sheet thickness) in a direction parallel to the rolling direction from each laminated sheet. In the tensile test, the test was performed at room temperature of 20° C. according to JIS Z2241 (1980) (Method for Tensile Test of Metal Material). The crosshead speed was 5 mm/min, and the test was performed at a constant speed until the test piece was fractured.

### <Erosion Resistance>

With respect to each Example, the erosion resistance was evaluated by measuring the erosion depth. The laminated sheet before heating corresponding to brazing was coated with from 3 to 5 g/m² of a commercially available non-corrosive flux and held at 600° C. for 5 minutes or more in an atmosphere having an oxygen concentration of 200 ppm or less to manufacture a brazing test piece. The longitudinal cross-section along the rolling direction of the laminated sheet having subjected to heating corresponding to brazing was pretreated by mechanical polishing and electrolytic etching and then observed in five visual fields by means of a 100-power optical microscope. The penetration depth (erosion depth) of the brazing filler material into the core material was measured in those five visual fields, and the erosion depth (μm) was determined as an average value thereof.

### <Fatigue Properties>

The fatigue life (fatigue properties) was evaluated at ordinary temperature by means of a known pulsating plane bending fatigue tester. More specifically, a test piece of 10 mm×60 mm×sheet thickness was cut out from each laminated sheet after the above-described heating corresponding to brazing, in parallel with the rolling direction to produce a test piece. One end of the test piece was attached to the fixed side of the pulsating plane bending fatigue tester, and another end of the test piece was sandwiched between knife edges on the driving side.

In the bending fatigue test, plane bending of the test piece was repeatedly performed by moving the positions of the knife edges to make the pulsating width constant (5 mm in the vertical direction) while changing the test piece set length. Here, the set length of the test piece was adjusted with an additional bending stress such that the strain amount of the fractured part becomes about 0.009 at maximum. Under such conditions, the number of repetitions of plane bending until fracture of each test piece was determined. In the evaluation, the fatigue life was rated as very good: A when the number was 12,000 or more; the fatigue life was rated as good: B when the number was 10,000 or more; and the fatigue life was rated as insufficient: C when the number was less than 10,000.

As for the strain amount of the fractured part, since a strain gauge cannot be directly stuck to the fractured region, the strain amount of the fractured region was estimated by sticking the strain gauge at predetermined two or three places slightly apart from the fractured region and interpolating the strain amount of the fractured region from the strain value of the strain gauge at each test piece length, and based on this, the load stress, i.e., the set length of the test piece, was adjusted.

These results are shown in Table 2.

TABLE 2

| | | Laminated Aluminum Alloy Sheet | | | | | Laminated Aluminum Alloy Sheet After | | | | | |
|---|---|---|---|---|---|---|---|---|---|---|---|---|
| | | | Average | | | | Heating Corresponding to Brazing | | | | | |
| | | Code of | Temperature | | | Number | Average | Average | Proportion of | | | Fatigue |
| | | Core | Rise Rate | | | Density of | Grain Size in | Aspect | Small-Angle | | | Properties |
| | | Material | in Soaking | Soaking | | Dispersoids | Rolling | Ratio of | Grain | | | Rating of |
| | | Composi- | (400° C. | Temper- | | of Core | Direction of | Grain of | Boundaries of | Tensile | Erosion | Bending |
| Divi- | | tion of | or more) | ature | | Material | Core Material | Core | Grain of Core | Strength | Depth | Repetition |
| sion | No. | Table 1 | (° C./hr) | (° C.) | Temper | (/μm³) | (μm) | Material | Material (%) | (MPa) | (μm) | Number |
| Ex. | 1 | A | 20 | 500 | H1n | 21.9 | 53 | 4.0 | 7.8 | 180 | 39 | A |
| | 2 | B | 35 | 480 | H1n | 22.3 | 93 | 4.1 | 7.5 | 183 | 31 | A |
| | 3 | C | 40 | 490 | H1n | 21.6 | 85 | 4.3 | 7.1 | 187 | 32 | A |
| | 4 | D | 80 | 520 | H1n | 24.7 | 92 | 4.9 | 7.8 | 219 | 28 | A |
| | 5 | E | 55 | 580 | H1n | 20.1 | 55 | 3.3 | 9.1 | 237 | 26 | B |
| | 6 | F | 45 | 515 | H1n | 33.6 | 112 | 4.8 | 6.9 | 209 | 26 | A |
| | 7 | G | 90 | 510 | H1n | 47.5 | 202 | 5.2 | 6.3 | 242 | 25 | A |
| | 8 | H | 50 | 560 | H1n | 20.4 | 61 | 3.3 | 8.4 | 227 | 30 | B |
| | 9 | I | 35 | 490 | H1n | 22.9 | 128 | 5.1 | 7.7 | 216 | 28 | A |
| | 10 | J | 65 | 520 | H1n | 42.9 | 197 | 6.5 | 6.2 | 235 | 25 | A |
| | 11 | K | 180 | 510 | H1n | 78.3 | 263 | 11.2 | 5.3 | 249 | 20 | A |
| | 12 | L | 140 | 520 | H1n | 62.9 | 208 | 9.7 | 5.5 | 246 | 23 | A |
| | 13 | M | 40 | 570 | H1n | 20.2 | 58 | 3.1 | 9.7 | 223 | 31 | B |
| | 14 | C | 30 | 520 | H2n | 22.3 | 86 | 4.2 | 7.5 | 193 | 32 | A |
| | 15 | D | 70 | 595 | H2n | 20.7 | 52 | 3.2 | 9.4 | 232 | 27 | B |
| | 16 | G | 35 | 480 | H2n | 52.4 | 130 | 4.4 | 7.6 | 228 | 32 | A |
| | 17 | J | 120 | 490 | H2n | 65.6 | 211 | 8.6 | 5.7 | 237 | 22 | A |
| | 18 | K | 90 | 555 | H2n | 20.8 | 57 | 3.6 | 8.5 | 234 | 24 | B |
| Com. | 19 | B | 15 | 470 | H1n | 86.1 | 64 | 2.8 | 11.2 | 146 | 37 | C |
| Ex. | 20 | B | 60 | 420 | H1n | 90.4 | 81 | 2.7 | 11.6 | 159 | 32 | C |
| | 21 | O | 70 | 500 | H1n | 18.8 | 48 | 2.4 | 9.9 | 144 | 53 | C |
| | 22 | P | 60 | 490 | H1n | 21.4 | 89 | 3.2 | 13.9 | 159 | 34 | C |
| | 23 | Q | 80 | 480 | H1n | 16.7 | 45 | 2.5 | 9.8 | 158 | 71 | C |
| | 24 | R | 50 | 480 | H1n | 23.7 | 92 | 2.3 | 9.4 | 162 | 31 | C |
| | 25 | S | 20 | 480 | H1n | 93.2 | 115 | 2.6 | 12.1 | 174 | 30 | C |
| | 26 | T | 25 | 490 | H1n | 97.8 | 108 | 2.4 | 14.6 | 169 | 29 | C |
| | 27 | U | 30 | 580 | H1n | 19.8 | 46 | 2.2 | 10.8 | 144 | 46 | C |
| | 28 | V | 30 | 500 | H1n | 19.4 | 46 | 2.6 | 13.3 | 163 | 47 | C |
| | 29 | G | 120 | 430 | H2n | 84.5 | 52 | 2.6 | 10.8 | 166 | 39 | C |
| | 30 | E | — | — | H1n | 112.6 | 184 | 2.7 | 13.1 | 174 | 25 | C |
| | 31 | B | 35 | 510 | H2n | 9.6 | 99 | 2.4 | 9.2 | 140 | 39 | C |
| | 32 | N | 15 | 560 | H1n | 9.8 | 73 | 2.5 | 11.6 | 160 | 35 | C |

As shown in Table 2, in the laminated sheets of Example Nos. 1 to 18, the requirements of the present invention were satisfied and therefore, such results were obtained that not only the tensile strength was 180 MPa or more but also the erosion depth was 40 μm or less and furthermore, the rating of fatigue properties was very good or good. In other words, it was understood that the laminate sheet satisfying the requirements of the present invention is excellent in the strength (strength after brazing), erosion resistance and fatigue properties.

On the other hand, in the laminated sheets of Comparative Example Nos. 19 to 32, any of the requirements specified in the present invention was not satisfied and therefore, good evaluations were not obtained.

Specifically, in the laminated sheet of Comparative Example No. 19, the average temperature rise rate in soaking (high-temperature region: 400° C. or more) was too slow, and therefore the number density of dispersoids before heating corresponding to brazing, the average aspect ratio after heating corresponding to brazing, and the proportion of small-angle grain boundaries did not fall in the ranges specified in the present invention. Consequently, the tensile strength was less than 180 MPa and the fatigue properties were insufficient.

In the laminated sheet of Comparative Example No. 20, the soaking temperature was too low, and therefore the number density of dispersoids before heating corresponding to brazing, the average aspect ratio after heating corresponding to brazing, and the proportion of small-angle grain boundaries did not fall in the ranges specified in the present invention. Consequently, the tensile strength was less than 180 MPa and the fatigue properties were insufficient.

In the laminated sheet of Comparative Example No. 29, the soaking temperature was also too low, and therefore the number density of dispersoids before heating corresponding to brazing, the average aspect ratio after heating corresponding to brazing, and the proportion of small-angle grain boundaries did not fall in the ranges specified in the present invention. Consequently, the tensile strength was less than 180 MPa and the fatigue properties were insufficient.

In the laminated sheets of Comparative Example Nos. 21 to 28, the core material composition failed in satisfying the requirements of the present invention, and therefore at least one of the number density of dispersoids before heating corresponding to brazing, the average grain size and average aspect ratio after heating corresponding to brazing, and the proportion of small-angle grain boundaries did not fall in the range specified in the present invention. Consequently, the tensile strength was less than 180 MPa and the fatigue properties were insufficient (and the erosion depth exceeded 40 μm).

The laminated sheet of Comparative Example No. 30 is, as described above, a laminated sheet manufactured by the method described in Patent Document 1, where unlike the conditions for the manufacture of the laminated sheet of the present invention, soaking was not performed. Accordingly, in the laminated sheet of Comparative Example No. 30, the number density of dispersoids before heating corresponding to brazing, the average aspect ratio after heating corresponding to brazing, and the proportion of small-angle grain boundaries did not fall in the ranges specified in the present invention. Consequently, the tensile strength was less than 180 MPa and the fatigue properties were insufficient.

The laminated sheet of Comparative Example No. 31 is, as described above, a laminated sheet manufactured by the method described in Patent Document 2, where unlike the conditions for the manufacture of the laminated sheet of the present invention, rough annealing was performed under predetermined conditions. Accordingly, in the laminated sheet of Comparative Example No. 31, the number density of dispersoids before heating corresponding to brazing and the average aspect ratio after heating corresponding to brazing did not fall in the ranges specified in the present invention. Consequently, the tensile strength was less than 180 MPa and the fatigue properties were insufficient.

The laminated sheet of Comparative Example No. 32 is, as described above, a laminated sheet manufactured by the method described in Patent Document 3, and although the average temperature rise rate in soaking is not described therein, the condition for obtaining mechanical properties equal to Patent Document 3 was that the average temperature rise rate at 400° C. or more is 15° C./hr. This condition is outside the range of the condition of the present invention, and in the laminated sheet of Comparative Example No. 32, the number density of dispersoids before heating corresponding to brazing, the average aspect ratio after heating corresponding to brazing, and the proportion of small-angle grain boundaries did not fall in the ranges specified in the present invention. Consequently, the tensile strength was less than 180 MPa and the fatigue properties was insufficient.

In Patent Document 4, the addition amount of Si in the core material is restricted to 0.2 mass % or less and is smaller than the preferable range of the addition amount of Si of this application. Because of this, it is considered that the Si element was not sufficiently dissolved in solid and at least one of the number density of dispersoids before heating corresponding to brazing, the average grain size and aspect ratio after heating corresponding to brazing, and the proportion of small-angle grain boundaries did not fall in the range specified in the present invention. As a result, it is considered that a not good result was obtained in at least one of the tensile strength, the fatigue properties and the erosion depth.

While the present invention has been described in detail and with reference to specific embodiments thereof, it will be apparent to one skilled in the art that various changes and modifications can be made therein without departing from the spirit and scope of the present invention.

The present application is based on a Japanese patent application filed on Mar. 31, 2014 (Application No. 2014-74200), the contents thereof being incorporated herein by reference.

### INDUSTRIAL APPLICABILITY

The laminated aluminum alloy sheet of the present invention is excellent in the strength after brazing, the erosion resistance, the fatigue properties, etc. and is useful for a heat exchanger of an automobile, etc.

1: A laminated aluminum alloy sheet comprising a core material and a sacrificial material being clad on at least one side surface of the core material, wherein:
the core material comprises Mn: from 0.5 to 1.8 mass %, Si: from 0.4 to 1.5 mass % and Cu: from 0.05 to 1.2 mass %, and comprises at least one member of Fe: 1.0 mass % or less and Ti: 0.3 mass % or less, with the remainder being Al and unavoidable impurities; and
the core material has a number density of dispersoids having a particle diameter of 0.01 to 0.5 μm of from 20 to 80/μm³.

2: The laminated aluminum alloy sheet according to claim 1, wherein the core material further comprises at least one of the following (a) to (c):
(a) at least one member of Cr: from 0.02 to 0.4 mass % and Zr: from 0.02 to 0.4 mass %;
(b) Zn: more than 0 mass % and 1.0 mass % or less; and
(c) Mg: more than 0 mass % and 1.0 mass % or less.

3: The laminated aluminum alloy sheet according to claim 1, having a sheet thickness of 0.2 mm or less.

4: The laminated aluminum alloy sheet according to claim 1, wherein:
the core material has, as a microstructure after a heating corresponding to a brazing of the laminated aluminum alloy sheet, an average grain size in a rolling direction, in a longitudinal cross-section along the rolling direction at a sheet-thickness center, of 50 μm or more;
the core material has, as the microstructure, an average aspect ratio (average grain size in rolling direction/average grain size in sheet thickness direction) of grains at a sheet-thickness center of 3.0 or more; and
the core material has, as the microstructure, a proportion of a small-angle grain boundary having a tilt angle of 5 to 15° of 10.0% or less.

5: The laminated aluminum alloy sheet according to claim 2, having a sheet thickness of 0.2 mm or less.

6: The laminated aluminum alloy sheet according to claim 2, wherein:
the core material has, as a microstructure after a heating corresponding to a brazing of the laminated aluminum alloy sheet, an average grain size in a rolling direction, in a longitudinal cross-section along the rolling direction at a sheet-thickness center, of 50 um or more;
the core material has, as the microstructure, an average aspect ratio (average grain size in rolling direction/average grain size in sheet thickness direction) of grains at a sheet thickness center of 3.0 or more; and
the core material has, as the microstructure, a proportion of a small-angle grain boundary having a tilt angle of 5 to 15° of 10.0% or less.
